(19) United States
(12) Patent Application Publication
(10) Pub. No.: US 2026/0128751 A1
(43) Pub. Date: May 7, 2026

(54) RADIO FREQUENCY CIRCUIT

(71) Applicant: Murata Manufacturing Co., Ltd., Nagaokakyo-shi (JP)

(72) Inventors: Takeshi OSHIMA, Nagaokakyo-shi (JP); Hirotsugu MORI, Nagaokakyo-shi (JP)

(21) Appl. No.: 19/377,333

(22) Filed: Nov. 3, 2025

(30) Foreign Application Priority Data
Nov. 6, 2024 (JP) 2024-194423

(51) Int. Cl. H04B 1/00

(52) U.S. Cl. CPC H04B 1/001; H04B 1/006

(57) ABSTRACT

A radio frequency circuit includes a first band pass filter having a pass band corresponding to the uplink frequency range of LTE Band 28, a second band pass filter having a pass band corresponding to the downlink frequency range of LTE Band 28, a third band pass filter having a pass band including the uplink frequency range of LTE Band 28B and the downlink frequency range of LTE Band 29, and a switch group.

### CROSS REFERENCE TO RELATED APPLICATION

This application claims priority from Japanese Patent Application No. 2024-194423, filed on November 6, 2024. The content of this application is incorporated herein by reference in its entirety.

### BACKGROUND OF THE DISCLOSURE

### 1. Field of the Disclosure

The present disclosure relates to a radio frequency circuit.

### 2. Description of the Related Art

U.S. Patent Application Publication No. 2013/0244722 describes a radio frequency circuit that transmits and receives radio frequency signals in multiple bands.

### BRIEF SUMMARY OF THE DISCLOSURE

Long Term Evolution (LTE) Band 28 is divided into Band 28A on the low frequency side and Band 28B on the high frequency side for operational purposes.

Band 28 includes a 45 MHz uplink frequency range from 703 MHz (megahertz) to 748 MHz and a 45 MHz downlink frequency range from 758 MHz to 803 MHz.

Band 28A includes a 30 MHz uplink frequency range from 703 MHz to 733 MHz and a 30 MHz downlink frequency range from 758 MHz to 788 MHz.

Band 28B includes a 30 MHz uplink frequency range from 718 MHz to 748 MHz and a 30 MHz downlink frequency range from 773 MHz to 803 MHz.

In the present disclosure, Band 28 may be referred to as "B28" or "B28F", Band 28A may be referred to as "B28A", Band 28B may be referred to as "B28B", uplink may be referred to as "UL", and downlink may be referred to as "DL".

In recent years, there has been market demand for performing communications using a frequency band with a bandwidth greater than or equal to 40 MHz for each of uplink and downlink in Band 28. However, as described above, each of the uplink frequency range and the downlink frequency range in each of Band 28A and Band 28B has only a 30 MHz bandwidth. For this reason, it is necessary to use Band 28.

The frequency range from 470 MHz to 710 MHz is used for digital terrestrial television broadcasting in some countries (for example, Japan). For this reason, a specification called NS_17 is defined by the Third Generation Partnership Project (3GPP) (registered trademark) for the use of Band 28B. In other words, when using Band 28B, it is necessary to suppress signals in the frequency range from 470 MHz to 710 MHz.

Also, Band 29 is only for downlink. The frequency range of Band 29 is from 717 MHz to 728 MHz. In other words, Band 29 is included in the uplink frequency range of Band 28.

In the present disclosure, Band 29 may be referred to as "B29".

For the above reasons, a radio frequency circuit requires many filters and switches to transmit and receive radio frequency signals in Band 28, Band 28B, and Band 29.

The present disclosure is made in view of the above problem, and a possible benefit of the present disclosure is to transmit and receive radio frequency signals in Band 28, Band 28B, and Band 29 while preventing an increase in the circuit size.

According to an aspect of the present disclosure, a radio frequency circuit includes a radio frequency signal input terminal; a radio frequency signal output terminal; a radio frequency signal input-output terminal; a power amplifier including an input terminal that is electrically connected to the radio frequency signal input terminal; a low noise amplifier including an output terminal that is electrically connected to the radio frequency signal output terminal; a first band pass filter that has a pass band corresponding to the uplink frequency range of Long Term Evolution (LTE) Band 28; a second band pass filter that has a pass band corresponding to the downlink frequency range of LTE Band 28; a third band pass filter that has a pass band including the uplink frequency range of LTE Band 28B and the downlink frequency range of LTE Band 29; and a switch group including a first terminal that electrically connects the output terminal of the power amplifier to a first end of the first band pass filter, a second terminal that electrically connects a second end of the first band pass filter to the radio frequency signal input-output terminal, a third terminal that electrically connects the input terminal of the low noise amplifier to a first end of the second band pass filter, a fourth terminal that electrically connects a second end of the second band pass filter to the radio frequency signal input-output terminal, a fifth terminal that electrically connects the output terminal of the power amplifier to a first end of the third band pass filter, a sixth terminal that electrically connects a second end of the third band pass filter to the radio frequency signal input-output terminal, and a seventh terminal that electrically connects the input terminal of the low noise amplifier to the first end of the third band pass filter.

The present disclosure makes it possible to transmit and receive radio frequency signals in Band 28, Band 28B, and Band 29 while preventing an increase in the circuit size.

### BRIEF DESCRIPTION OF THE SEVERAL VIEWS OF THE DRAWINGS

FIG. 1 is a diagram illustrating the frequency ranges of Long Term Evolution (LTE) Band 28 and Band 29;

FIG. 2 is a diagram illustrating a configuration of a radio frequency circuit according to a first embodiment;

FIG. 3 is a diagram for describing operations of the radio frequency circuit of the first embodiment during transmission and reception of radio frequency signals in Band 28;

FIG. 4 is a diagram for describing operations of the radio frequency circuit of the first embodiment during transmission and reception of radio frequency signals in Band 28B;

FIG. 5 is a diagram for describing an operation of the radio frequency circuit of the first embodiment during reception of a radio frequency signal in Band 29;

FIG. 6 is a diagram illustrating the frequency ranges of LTE Band 28 and Band 28B;

FIG. 7 is a diagram illustrating a configuration of a radio frequency circuit of a comparative example;

FIG. 8 is a diagram illustrating a case in which the radio frequency circuit of the first embodiment transmits and receives radio frequency signals in Band 28;

FIG. 9 is a diagram illustrating a configuration of a radio frequency circuit according to a second embodiment; and

FIG. 10 is a diagram for describing operations of the radio frequency circuit of the second embodiment during transmission and reception of radio frequency signals in Band 20.

### DETAILED DESCRIPTION OF THE DISCLOSURE

Embodiments of the present disclosure are described in detail below with reference to the drawings. However, the present disclosure is not limited to the embodiments described below. Needless to say, the embodiments are examples, and partial substitutions and combinations of components in different embodiments may be made. In the second and subsequent embodiments, descriptions of features that are the same as those in the first embodiment are omitted, and only differences are described. In particular, the description of the same effect provided by the same feature is not repeated for each embodiment.

### First Embodiment

Descriptions of Frequency Ranges of Band 28 and Band 29

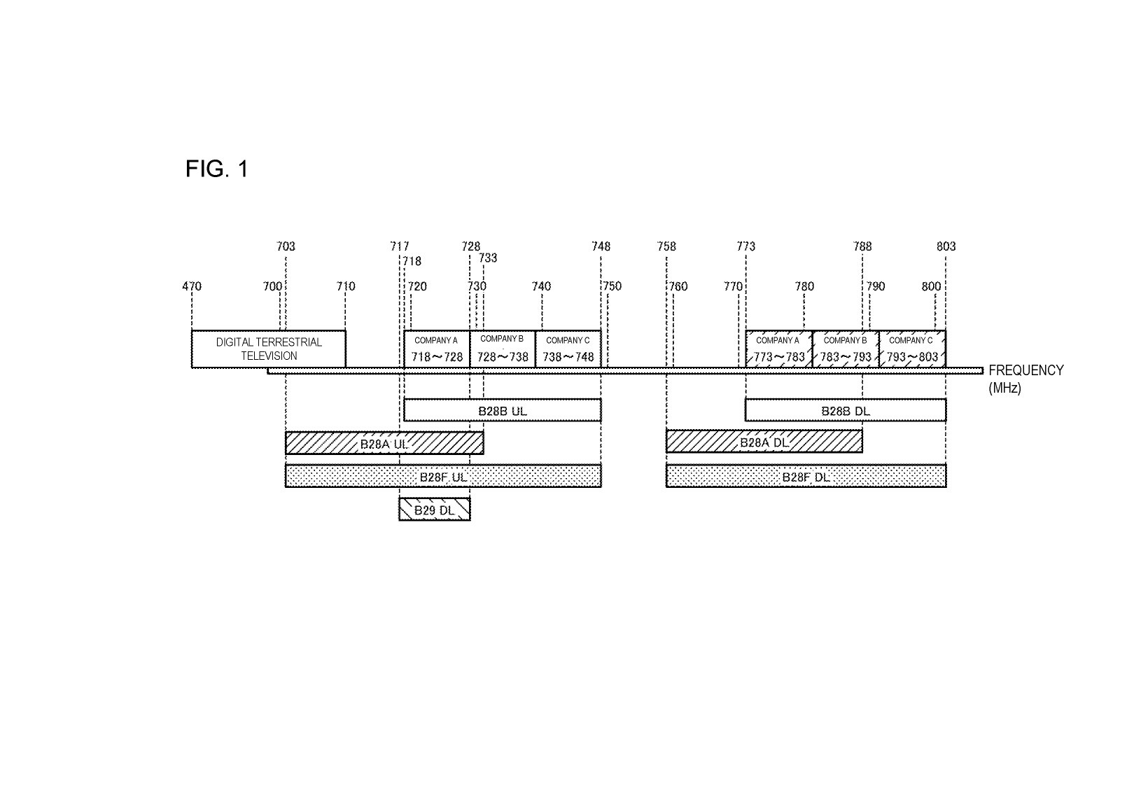

FIG. 1 is a diagram illustrating the frequency ranges of Long Term Evolution (LTE) Band 28 and Band 29.

Band 28 includes a 45 MHz uplink frequency range from 703 MHz (megahertz) to 748 MHz and a 45 MHz downlink frequency range from 758 MHz to 803 MHz.

Band 28A includes a 30 MHz uplink frequency range from 703 MHz to 733 MHz and a 30 MHz downlink frequency range from 758 MHz to 788 MHz.

Band 28B includes a 30 MHz uplink frequency range from 718 MHz to 748 MHz and a 30 MHz downlink frequency range from 773 MHz to 803 MHz.

The frequency range from 470 MHz to 710 MHz is used for digital terrestrial television broadcasting in some countries (for example, Japan).

For this reason, a specification called NS_17 is defined by the Third Generation Partnership Project (3GPP) (registered trademark) for the use of Band 28B. In other words, when using Band 28B, it is necessary to suppress signals in the frequency range from 470 MHz to 710 MHz.

Also, Band 29 is for downlink only. The frequency range of Band 29 is from 717 MHz to 728 MHz. In other words, Band 29 is included in the uplink frequency range of Band 28.

In Japan, the uplink frequency range of Band 28B from 718 MHz to 728 MHz and the downlink frequency range of Band 28B from 773 MHz to 783 MHz are assigned to Company A. Also, the frequency range from 728 MHz to 738 MHz in the uplink frequency range of Band 28B and the frequency range from 783 MHz to 793 MHz in the downlink frequency range of Band 28B are allocated to Company B. Furthermore, the frequency range from 738 MHz to 748 MHz in the uplink frequency range of Band 28B and the frequency range from 793 MHz to 803 MHz in the downlink frequency range of Band 28B are assigned to Company C.

### Configuration

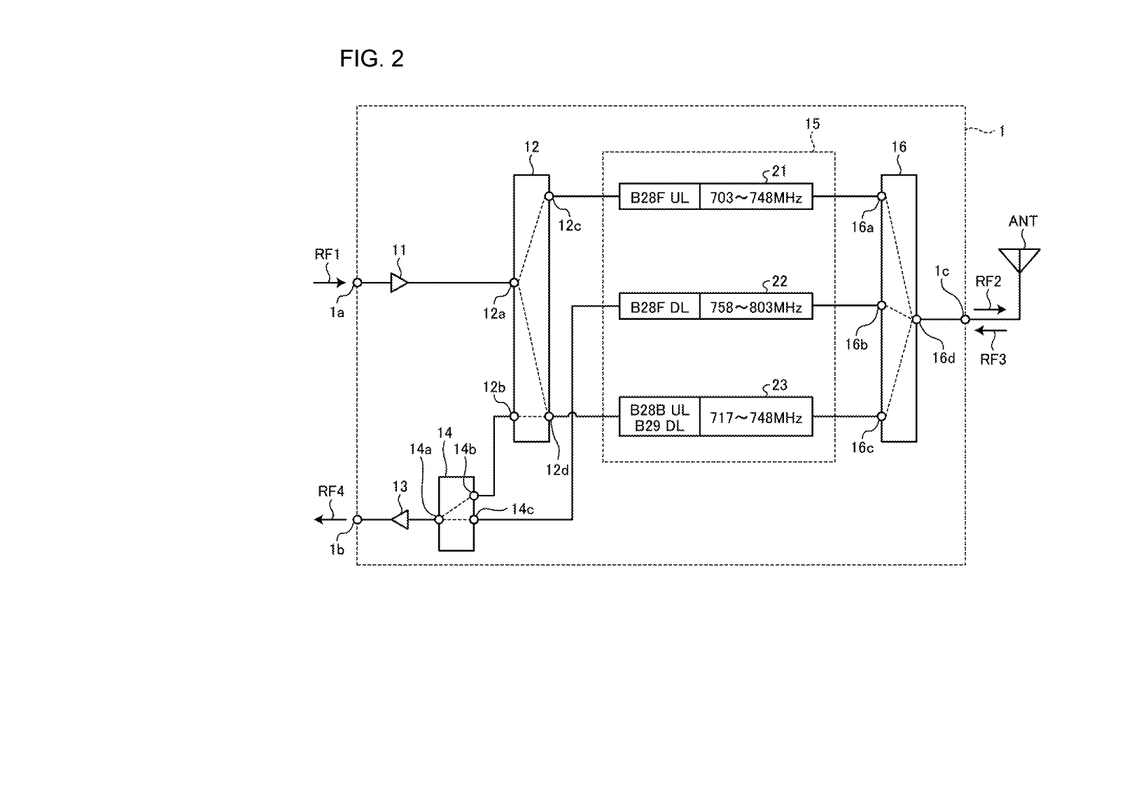

FIG. 2 is a diagram illustrating a configuration of a radio frequency circuit according to the first embodiment.

For example, a radio frequency circuit 1 is a radio frequency module in which components (e.g., surface mount devices (SMD)) are mounted on a substrate (e.g., a printed wiring board (PWB)). However, the present disclosure is not limited to this example. Also, for example, the radio frequency module is provided in a communication apparatus, such as a smartphone or a tablet. However, the present disclosure is not limited to this example.

The radio frequency circuit 1 amplifies a radio frequency signal RF1 inputted from a terminal 1a, passes the amplified radio frequency signal RF1 through a band pass filter, and outputs a radio frequency signal RF2 from a terminal 1c.

In the illustrated example, an antenna ANT is electrically connected to the terminal 1c. However, the present disclosure is not limited to this example.

Also, the radio frequency circuit 1 amplifies a radio frequency signal RF3 that is inputted from the terminal 1c and passed through a band pass filter, and outputs a radio frequency signal RF4 from a terminal 1b.

The terminal 1a corresponds to an example of the "radio frequency signal input terminal" of the present disclosure. The terminal 1b corresponds to an example of the "radio frequency signal output terminal" of the present disclosure. The terminal 1c corresponds to an example of the "radio frequency signal input-output terminal" of the present disclosure. The radio frequency signal RF1 and the radio frequency signal RF2 correspond to examples of the "radio frequency transmission signal" of the present disclosure. The radio frequency signal RF3 and the radio frequency signal RF4 correspond to examples of the "radio frequency reception signal" of the present disclosure.

The radio frequency circuit 1 includes a power amplifier 11, a first switch 12, a low noise amplifier 13, a second switch 14, a filter group 15, and a third switch 16.

The first switch 12 includes terminals 12a to 12d.

The first switch 12 electrically connects the terminals 12a and 12c, the terminals 12a and 12d, or the terminals 12b and 12d.

The second switch 14 includes terminals 14a to 14c.

The second switch 14 electrically connects the terminals 14a and 14b or the terminals 14a and 14c.

The third switch 16 includes terminals 16a to 16d.

The third switch 16 electrically connects the terminals 16a and 16d, the terminals 16b and 16d, or the terminals 16c and 16d.

The first switch 12, the second switch 14, and the third switch 16 correspond to an example of the "switch group" of the present disclosure. The terminal 12c corresponds to an example of the "first terminal of the switch group" of the present disclosure. The terminal 16a corresponds to an example of the "second terminal of the switch group" of the present disclosure. The terminal 14c corresponds to an example of the "third terminal of the switch group" of the present disclosure. The terminal 16b corresponds to an example of the "fourth terminal of the switch group" of the present disclosure. The terminal 12d corresponds to an example of the "fifth terminal of the switch group" of the present disclosure. The terminal 16c corresponds to an example of the "sixth terminal of the switch group" of the present disclosure. The terminal 12b corresponds to an example of the "seventh terminal of the switch group" of the present disclosure.

The terminal 12a of the first switch 12 corresponds to an example of the "first terminal of the first switch" of the present disclosure. The terminal 12b of the first switch 12 corresponds to an example of the "second terminal of the first switch" of the present disclosure. The terminal 12c of the first switch 12 corresponds to an example of the "third terminal of the first switch" of the present disclosure. The terminal 12d of the first switch 12 corresponds to an example of the "fourth terminal of the first switch" of the present disclosure.

The terminal 14a of the second switch 14 corresponds to an example of the "first terminal of the second switch" of the present disclosure. The terminal 14b of the second switch 14 corresponds to an example of the "second terminal of the second switch" of the present disclosure. The terminal 14c of the second switch 14 corresponds to an example of the "third terminal of the second switch" of the present disclosure.

The terminal 16a of the third switch 16 corresponds to an example of the "first terminal of the third switch" of the present disclosure. The terminal 16b of the third switch 16 corresponds to an example of the "second terminal of the third switch" of the present disclosure. The terminal 16c of the third switch 16 corresponds to an example of the "third terminal of the third switch" of the present disclosure. The terminal 16d of the third switch 16 corresponds to an example of the "fourth terminal of the third switch" of the present disclosure.

The filter group 15 includes a first band pass filter 21 to a third band pass filter 23.

The first band pass filter 21 has a pass band ranging from 703 MHz to 748 MHz, which corresponds to the uplink frequency range of Band 28.

The second band pass filter 22 has a pass band ranging from 758 MHz to 803 MHz, which corresponds to the downlink frequency range of Band 28.

The third band pass filter 23 has a pass band including the uplink frequency range of Band 28B ranging from 718 MHz to 748 MHz and the downlink frequency range of Band 29 ranging from 717 MHz to 728 MHz. In other words, in total, the third band pass filter 23 has a pass band ranging from 717 MHz to 748 MHz.

The input terminal of the power amplifier 11 is electrically connected to the terminal 1a. The output terminal of the power amplifier 11 is electrically connected to the terminal 12a of the first switch 12.

The output terminal of the low noise amplifier 13 is electrically connected to the terminal 1b. The input terminal of the low noise amplifier 13 is electrically connected to the terminal 14a of the second switch 14.

The terminal 12b of the first switch 12 is electrically connected to the terminal 14b of the second switch 14.

The terminal 12c of the first switch 12 is electrically connected to a first end of the first band pass filter 21.

The terminal 12d of the first switch 12 is electrically connected to a first end of the third band pass filter 23.

The terminal 14c of the second switch 14 is electrically connected to a first end of the second band pass filter 22.

A second end of the first band pass filter 21 is electrically connected to the terminal 16a of the third switch 16.

A second end of the second band pass filter 22 is electrically connected to the terminal 16b of the third switch 16.

A second end of the third band pass filter 23 is electrically connected to the terminal 16c of the third switch 16.

The terminal 16d of the third switch 16 is electrically connected to the terminal 1c.

Operations for Transmitting and Receiving Radio Frequency Signals in Band 28

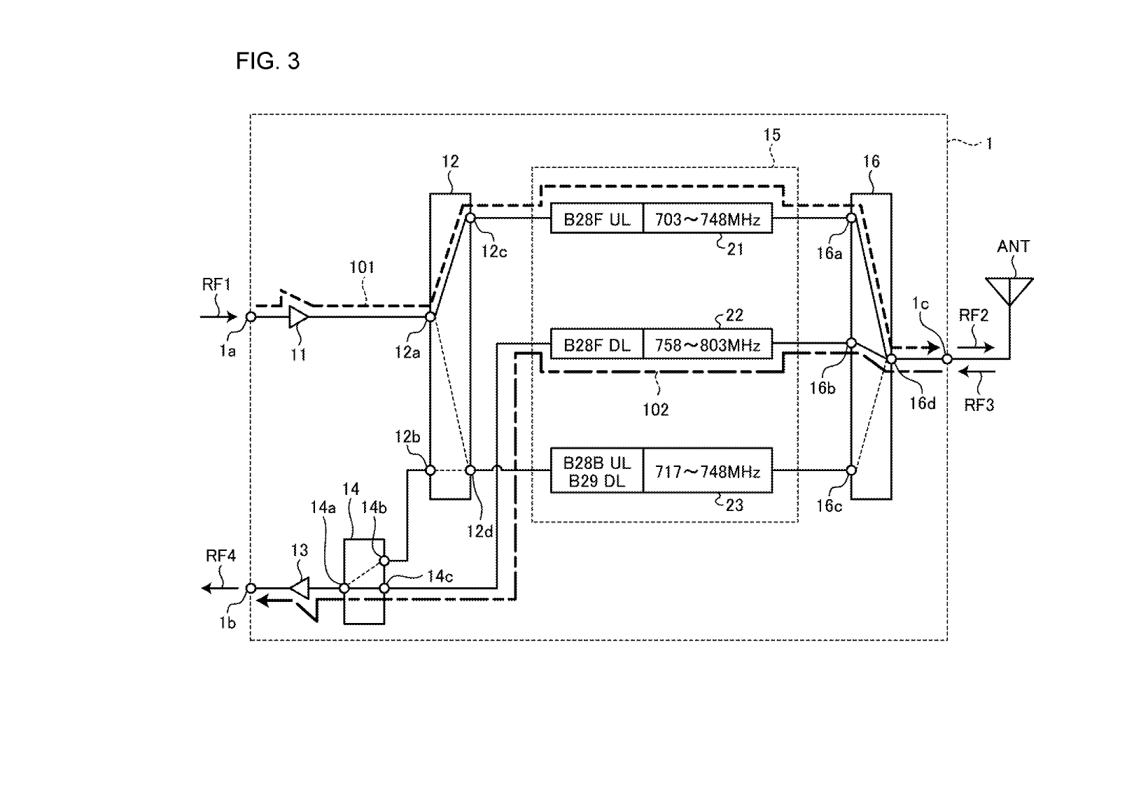

FIG. 3 is a diagram for describing operations of the radio frequency circuit of the first embodiment during transmission and reception of radio frequency signals in Band 28.

When radio frequency signals in Band 28 are transmitted and received, the first switch 12 electrically connects the terminal 12a to the terminal 12c. The second switch 14 electrically connects the terminal 14a to the terminal 14c. The third switch 16 electrically connects the terminal 16a to the terminal 16d and electrically connects the terminal 16b to the terminal 16d.

An arrow 101 in FIG. 3 represents a path along which a transmission signal (radio frequency signal RF1) in Band 28 flows. An arrow 102 represents a path along which a reception signal (radio frequency signal RF3) in Band 28 flows.

As indicated by the arrow 101, the radio frequency signal RF1 flows along the path: the terminal 1a → the power amplifier 11 → the terminal 12a of the first switch 12 → the terminal 12c of the first switch 12 → the first band pass filter 21 → the terminal 16a of the third switch 16 → the terminal 16d of the third switch 16 → the terminal 1c.

Also, as indicated by the arrow 102, the radio frequency signal RF3 flows along the path: the terminal 1c → the terminal 16d of the third switch 16 → the terminal 16b of the third switch 16 → the second band pass filter 22 → the terminal 14c of the second switch 14 → the terminal 14a of the second switch 14 → the low noise amplifier 13 → the terminal 1b.

Thus, the radio frequency circuit 1 can transmit and receive radio frequency signals in Band 28.

Operations for Transmitting and Receiving Radio Frequency Signals in Band 28B

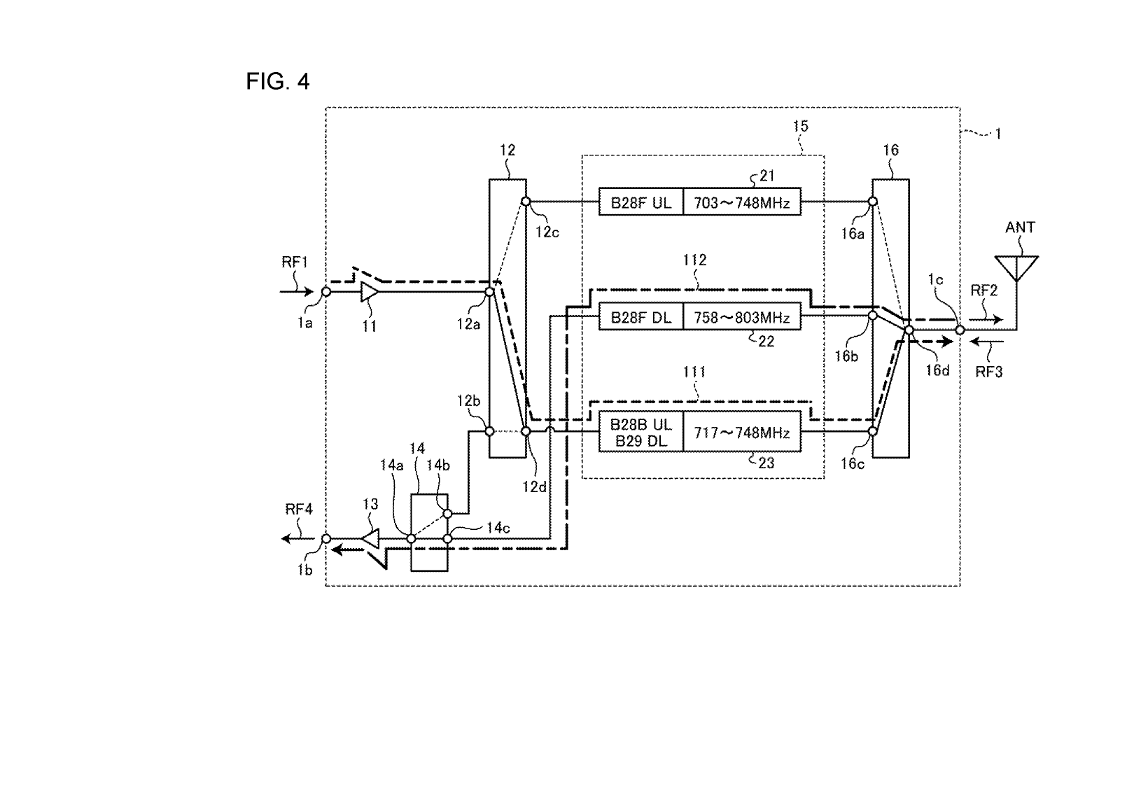

FIG. 4 is a diagram for describing operations of the radio frequency circuit of the first embodiment during transmission and reception of radio frequency signals in Band 28B.

When transmitting and receiving radio frequency signals in Band 28B, the first switch 12 electrically connects the terminal 12a to the terminal 12d. The second switch 14 electrically connects the terminal 14a to the terminal 14c. The third switch 16 electrically connects the terminal 16b to the terminal 16d and electrically connects the terminal 16c to the terminal 16d.

An arrow 111 in FIG. 4 represents a path along which a transmission signal (radio frequency signal RF1) in Band 28B flows. An arrow 112 represents a path along which a reception signal (radio frequency signal RF3) in Band 28B flows.

As indicated by the arrow 111, the radio frequency signal RF1 flows along the path: the terminal 1a → the power amplifier 11 → the terminal 12a of the first switch 12 → the terminal 12d of the first switch 12 → the third band pass filter 23 → the terminal 16c of the third switch 16 → the terminal 16d of the third switch 16 → the terminal 1c.

Also, as indicated by the arrow 112, the radio frequency signal RF3 flows along the path: the terminal 1c → the terminal 16d of the third switch 16 → the terminal 16b of the third switch 16 → the second band pass filter 22 → the terminal 14c of the second switch 14 → the terminal 14a of the second switch 14 → the low noise amplifier 13 → the terminal 1b.

Thus, the radio frequency circuit 1 can transmit and receive radio frequency signals in Band 28B.

### Operation for Receiving Radio Frequency Signal in Band 29

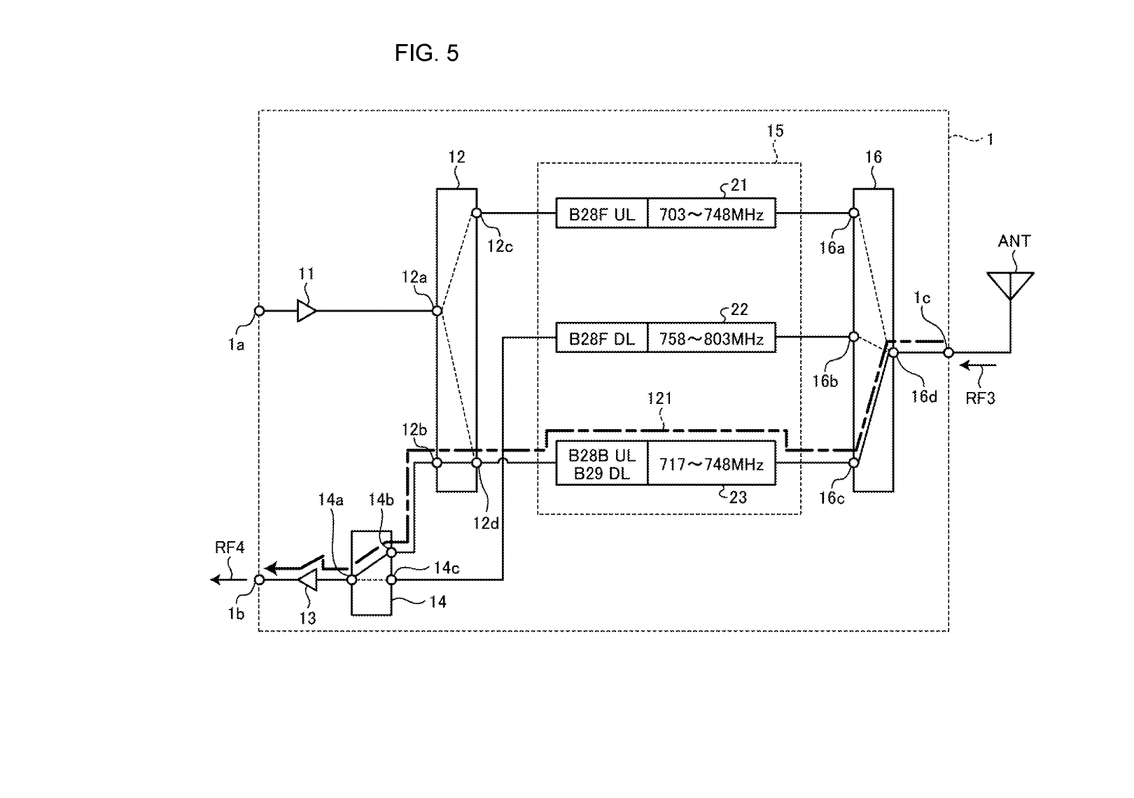

FIG. 5 is a diagram for describing an operation of the radio frequency circuit of the first embodiment during reception of a radio frequency signal in Band 29.

When receiving a radio frequency signal in Band 29, the first switch 12 electrically connects the terminal 12b to the terminal 12d. The second switch 14 electrically connects the terminal 14a to the terminal 14b. The third switch 16 electrically connects the terminal 16c to the terminal 16d.

An arrow 121 in FIG. 5 indicates a path along which a reception signal (radio frequency signal RF3) in Band 29 flows.

As indicated by the arrow 121, the radio frequency signal RF3 flows along the path: the terminal 1c → the terminal 16d of the third switch 16 → the terminal 16c of the third switch 16 → the third band pass filter 23 → the terminal 12d of the first switch 12 → the terminal 12b of the first switch 12 → the terminal 14b of the second switch 14 → the terminal 14a of the second switch 14 → the low noise amplifier 13 → the terminal 1b.

Thus, the radio frequency circuit 1 can receive radio frequency signals in Band 29.

### Effects

(1) Even with a small circuit size (three switches and three filters in the first embodiment), the radio frequency circuit 1 can transmit and receive radio frequency signals in Band 28, Band 28B, and Band 29.

(2) Also, the radio frequency circuit 1 can mitigate the reduction in reception sensitivity during the transmission and reception of radio frequency signals in Band 28.

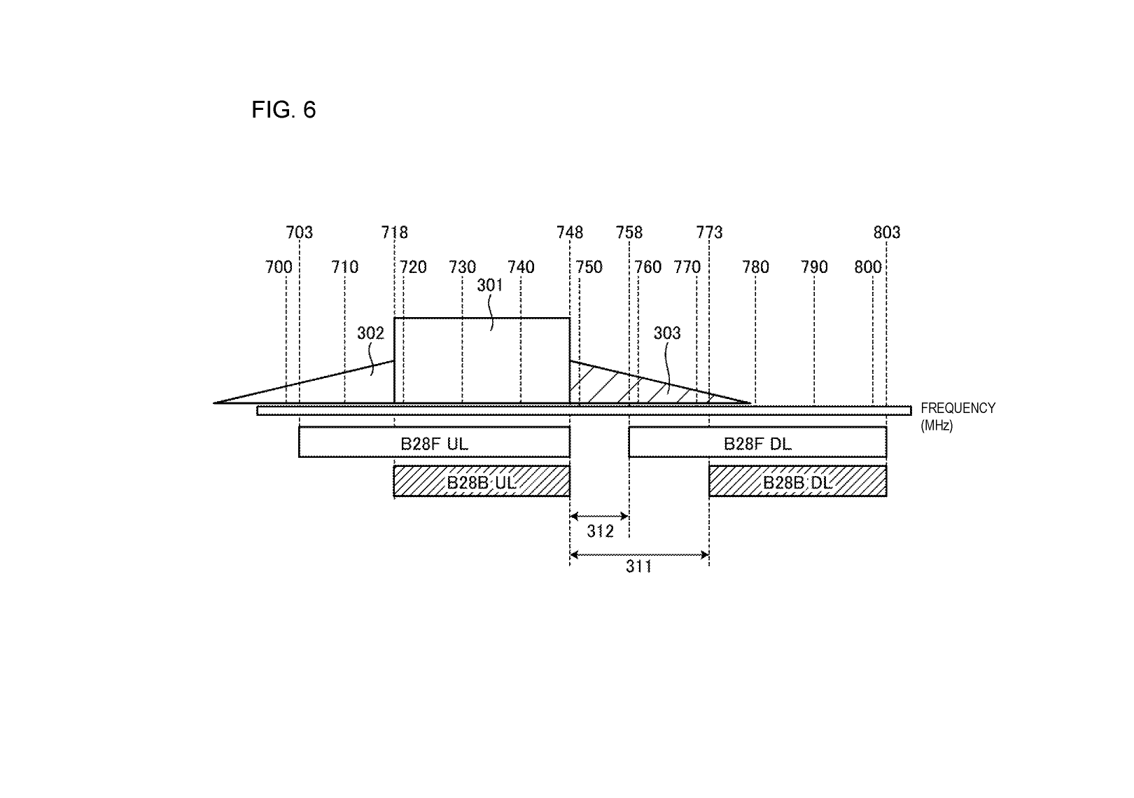

FIG. 6 is a diagram illustrating the frequency ranges of LTE Band 28 and Band 28B.

A region 301 in FIG. 6 indicates the frequency range and the strength of uplink radio frequency signals in Band 28B. A region 302 indicates the frequency range and the strength of unwanted low-frequency components of uplink radio frequency signals in Band 28B. A region 303 indicates the frequency range and the strength of unwanted high frequency components of uplink radio frequency signals in Band 28B.

The maximum uplink frequency of Band 28B is 748 MHz. The minimum downlink frequency of Band 28B is 773 MHz. That is, as indicated by an arrow 311, there is a 25 MHz gap between the uplink frequency range of Band 28B and the downlink frequency range of Band 28B.

Therefore, the signal strength of the unwanted components indicated by the region 303 is small at frequencies greater than or equal to 773 MHz. That is, the reduction in the reception sensitivity in the downlink frequency range of Band 28B caused by the uplink transmission in Band 28B is small.

On the other hand, the maximum uplink frequency of Band 28 is 748 MHz that is the same as the maximum frequency of Band 28B. The minimum downlink frequency of Band 28 is 758 MHz. That is, as indicated by an arrow 312, the gap between the uplink frequency range of Band 28 and the downlink frequency range of Band 28 is only 10 MHz.

Therefore, the signal strength of the unwanted components indicated by the region 303 (which is common to Band 28B and Band 28) is large at 758 MHz. That is, the reduction in the reception sensitivity in the downlink frequency range of Band 28 caused by the uplink transmission in Band 28 is large.

For this reason, the radio frequency circuit 1 mitigates the reduction in reception sensitivity during the transmission and reception of radio frequency signals in Band 28. This feature is described using a comparative example.

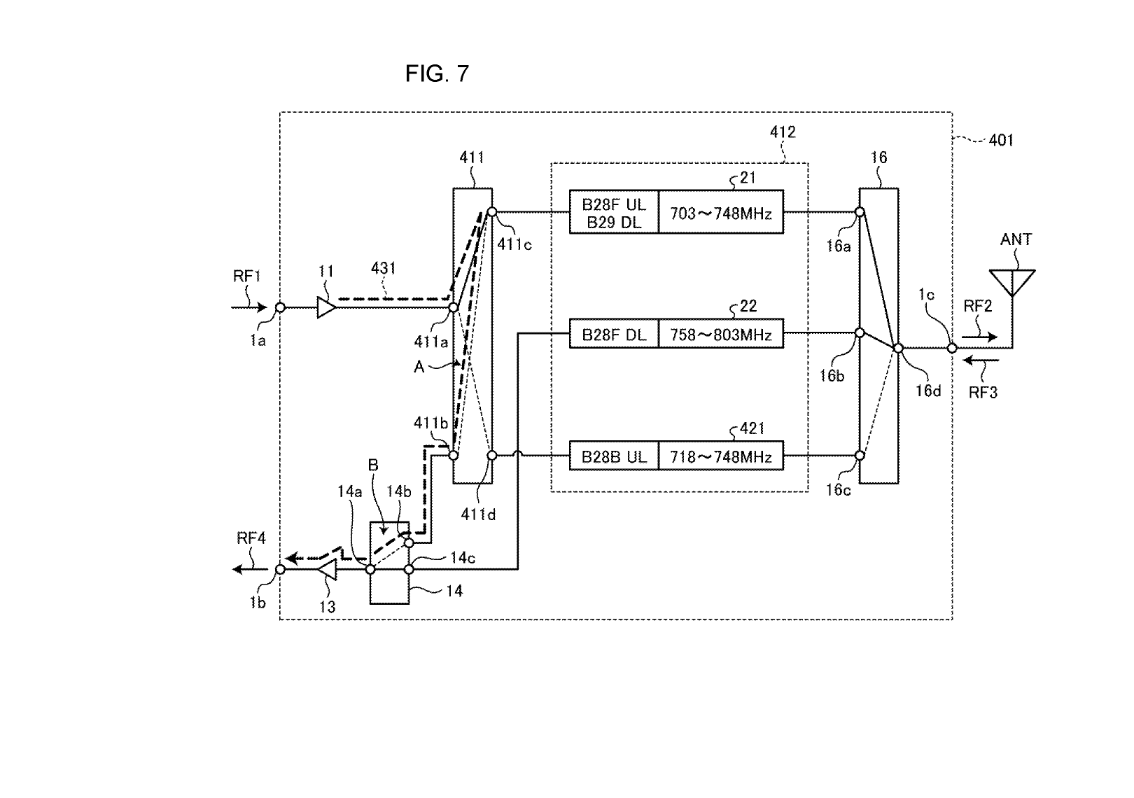

FIG. 7 is a diagram illustrating a configuration of a radio frequency circuit of a comparative example.

Compared with the radio frequency circuit 1 of the first embodiment, a radio frequency circuit 401 of the comparative example includes a first switch 411 and a filter 412 in place of the first switch 12 and the filter group 15.

Compared with the filter group 15, the filter 412 includes a third filter 421 in place of the third band pass filter 23.

The third filter 421 has a pass band ranging from 718 MHz to 748 MHz, which corresponds to the uplink frequency range of Band 28B.

Accordingly, in the radio frequency circuit 401 of the comparative example, the first band pass filter 21, instead of the third filter 421, passes downlink radio frequency signals in Band 29.

When radio frequency signals in Band 28 are transmitted and received, the first switch 411 electrically connects a terminal 411a to a terminal 411c.

When radio frequency signals in Band 28B are transmitted and received, the first switch 411 electrically connects the terminal 411a to a terminal 411d.

When radio frequency signals in Band 29 are transmitted and received, the first switch 411 electrically connects the terminal 411c to a terminal 411b.

FIG. 7 illustrates a case in which the radio frequency circuit 401 transmits and receives radio frequency signals in Band 28.

An arrow 431 in FIG. 7 indicates a path through which a transmission signal (radio frequency signal RF1) in Band 28 leaks into the terminal 1b.

As indicated by the arrow 431, when radio frequency signals in Band 28 are transmitted and received, a transmission signal (radio frequency signal RF1) in Band 28 outputted from the power amplifier 11 leaks through the path: the power amplifier 11 → the terminal 411a of the first switch 411 → the terminal 411c of the first switch 411 → the terminal 411b of the first switch 411 → the terminal 14b of the second switch 14 → the terminal 14a of the second switch 14 → the low noise amplifier 13 → the terminal 1b. This results in a decrease in reception sensitivity.

In the path indicated by the arrow 431, isolation is provided in a section A between the terminals 411c and 411b of the first switch 411 and in a section B between the terminals 14b and 14a of the second switch 14. When the attenuation of the radio frequency signal in each of the sections is, for example, 20 dB (decibels), the radio frequency signal is attenuated by 40 dB through the entire path indicated by the arrow 431.

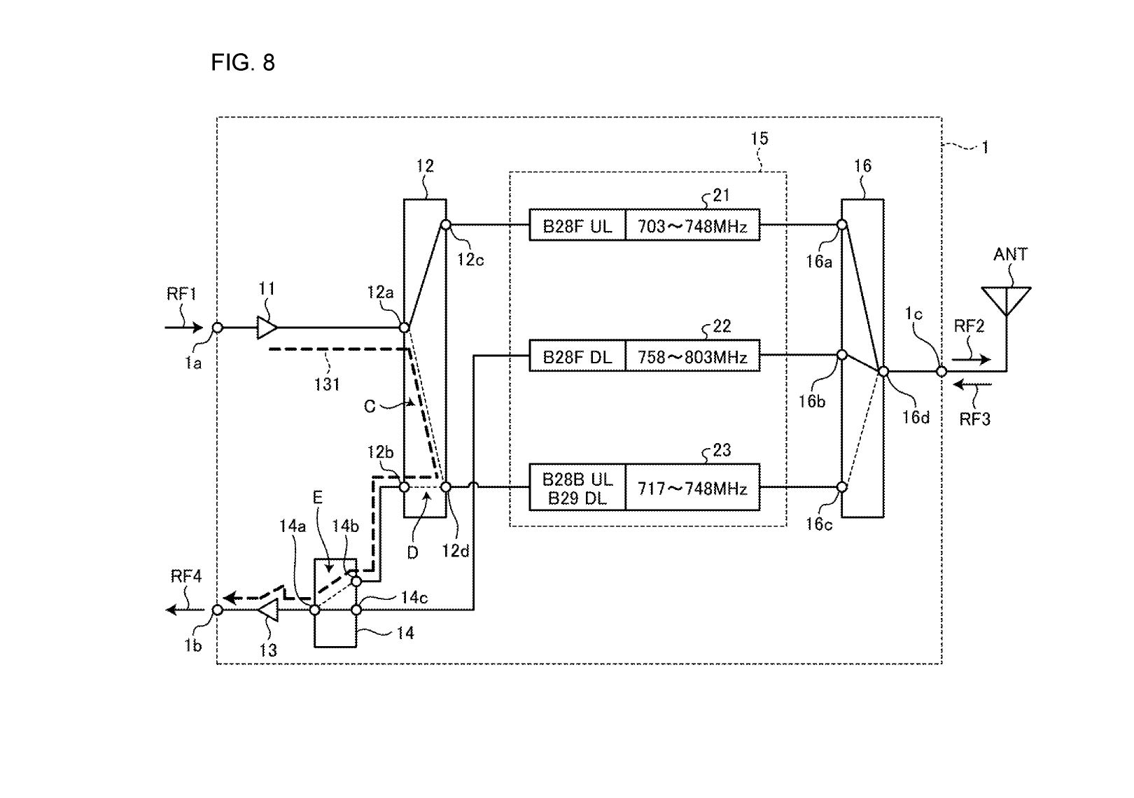

FIG. 8 is a diagram illustrating a case in which the radio frequency circuit of the first embodiment transmits and receives radio frequency signals in Band 28.

FIG. 8 illustrates a case in which the radio frequency circuit 1 transmits and receives radio frequency signals in Band 28.

An arrow 131 in FIG. 8 indicates a path through which a transmission signal (radio frequency signal RF1) in Band 28 leaks into the terminal 1b.

As indicated by the arrow 131, when radio frequency signals in Band 28 are transmitted and received, a transmission signal (radio frequency signal RF1) in Band 28 outputted from the power amplifier 11 leaks through the path: the power amplifier 11 → the terminal 12a of the first switch 12 → the terminal 12d of the first switch 12 → the terminal 12b of the first switch 12 → the terminal 14b of the second switch 14 → the terminal 14a of the second switch 14 → the low noise amplifier 13 → the terminal 1b. This results in a decrease in reception sensitivity.

In the path indicated by the arrow 131, isolation is provided in a section C between the terminals 12a and 12d of the first switch 12, a section D between the terminals 12d and 12b of the first switch 12, and a section E between the terminals 14b and 14a of the second switch 14.

When the attenuation of the radio frequency signal in each of the sections is, for example, 20 dB, the radio frequency signal is attenuated by 60 dB through the entire path indicated by the arrow 131.

Accordingly, compared with the radio frequency circuit 401, the radio frequency circuit 1 can mitigate the reduction in reception sensitivity during the transmission and reception of radio frequency signals in Band 28.

### Second Embodiment

### Configuration

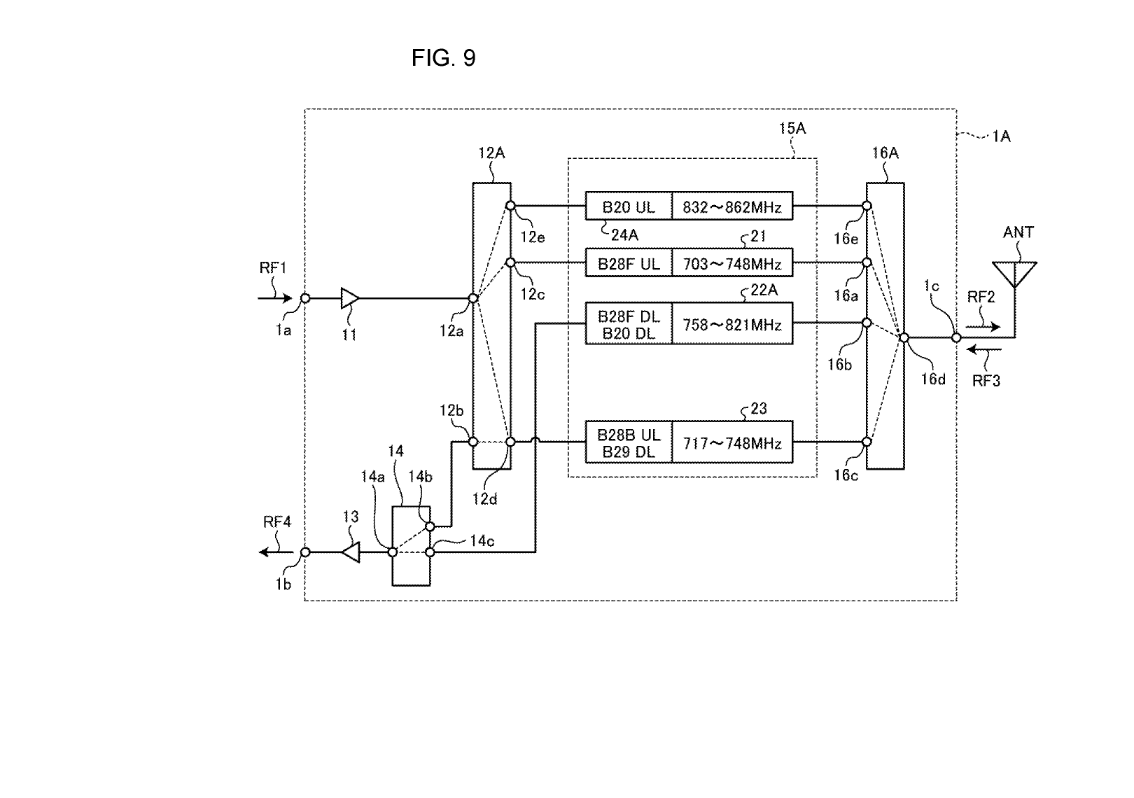

FIG. 9 is a diagram illustrating a configuration of a radio frequency circuit according to a second embodiment.

Compared with the radio frequency circuit 1 of the first embodiment, a radio frequency circuit 1A of the second embodiment can additionally transmit and receive radio frequency signals in Band 20.

Compared with the radio frequency circuit 1, the radio frequency circuit 1A includes a first switch 12A, a filter group 15A, and a third switch 16A in place of the first switch 12, the filter group 15, and the third switch 16.

Compared with the filter group 15, the filter group 15A includes a second band pass filter 22A in place of the second band pass filter 22. Also, compared with the filter group 15, the filter group 15A additionally includes a fourth band pass filter 24A.

The second band pass filter 22A has a pass band including the downlink frequency range of Band 28 ranging from 758 MHz to 803 MHz and the downlink frequency range of Band 20 ranging from 791 MHz to 821 MHz. In other words, in total, the second band pass filter 22A has a pass band ranging from 758 MHz to 821 MHz.

The fourth band pass filter 24A has a pass band ranging from 832 MHz to 862 MHz, which corresponds to the uplink frequency range of Band 20.

Compared with the first switch 12, the first switch 12A additionally includes a terminal 12e.

The terminal 12e of the first switch 12A corresponds to an example of the "fifth terminal of the first switch" of the present disclosure.

The terminal 12e of the first switch 12A is electrically connected to a first end of the fourth band pass filter 24A.

The first switch 12A electrically connects the terminals 12a and 12c, the terminals 12a and 12d, the terminals 12b and 12d, or the terminals 12a and 12e.

Compared with the third switch 16, the third switch 16A additionally includes a terminal 16e.

The terminal 16e of the third switch 16A corresponds to an example of the "fifth terminal of the third switch" of the present disclosure.

The terminal 16e of the third switch 16A is electrically connected to a second end of the fourth band pass filter 24A.

The third switch 16A electrically connects the terminals 16a and 16d, the terminals 16b and 16d, the terminals 16c and 16d, or the terminals 16e and 16d.

Operations for Transmitting and Receiving Radio Frequency Signals in Band 28, Band 28B, and Band 29

Operations of the radio frequency circuit 1A for transmitting and receiving radio frequency signals in Band 28, Band 28B, and Band 29 are the same as those of the radio frequency circuit 1, and therefore the illustration and descriptions of those operations are omitted.

### Operations for Transmitting and Receiving Radio Frequency Signals in Band 20

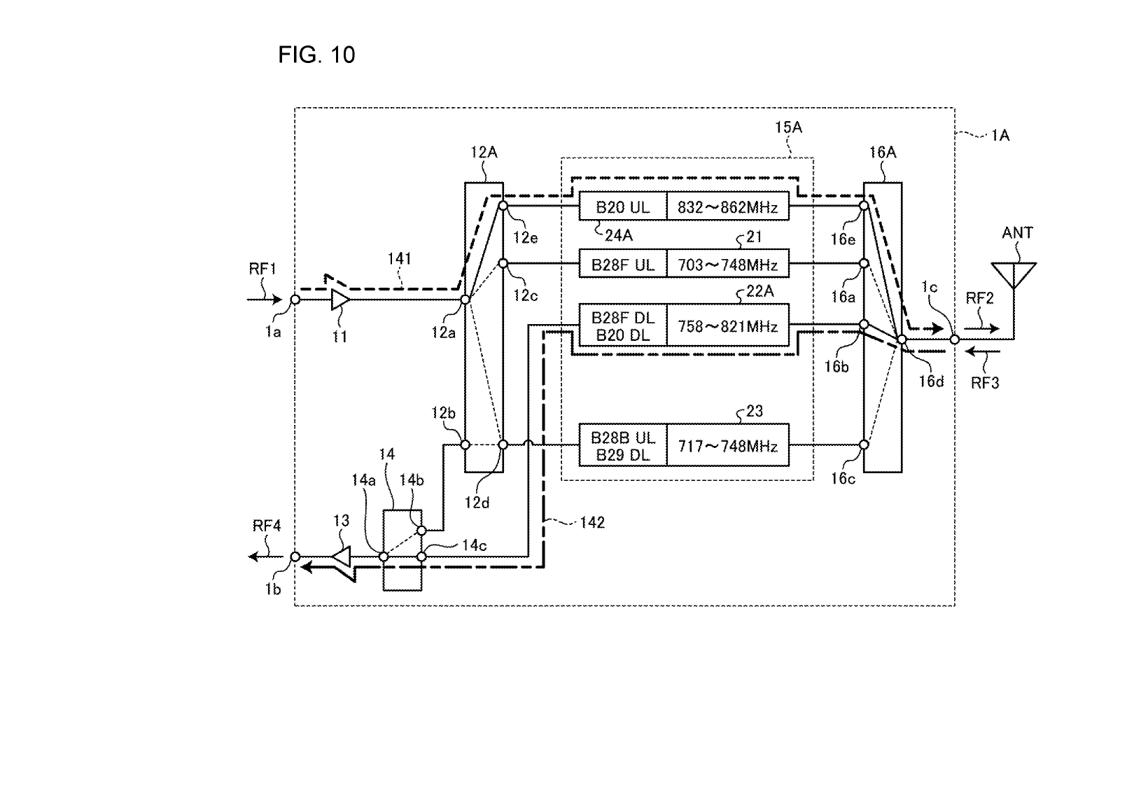

FIG. 10 is a diagram for describing operations of the radio frequency circuit of the second embodiment during transmission and reception of radio frequency signals in Band 20.

When radio frequency signals in Band 20 are transmitted and received, the first switch 12A electrically connects the terminal 12a to the terminal 12e. The second switch 14 electrically connects the terminal 14a to the terminal 14c. The third switch 16A electrically connects the terminal 16b to the terminal 16d and electrically connects the terminal 16e to the terminal 16d.

An arrow 141 in FIG. 10 indicates a path along which a transmission signal (radio frequency signal RF1) in Band 20 flows. An arrow 142 indicates a path along which a reception signal (radio frequency signal RF3) in Band 20 flows.

As indicated by the arrow 141, the radio frequency signal RF1 flows along the path: the terminal 1a → the power amplifier 11 → the terminal 12a of the first switch 12A → the terminal 12e of the first switch 12A → the fourth band pass filter 24A → the terminal 16e of the third switch 16A → the terminal 16d of the third switch 16A → the terminal 1c.

Also, as indicated by the arrow 142, the radio frequency signal RF3 flows along the path: the terminal 1c → the terminal 16d of the third switch 16A → the terminal 16b of the third switch 16A → the second band pass filter 22A → the terminal 14c of the second switch 14 → the terminal 14a of the second switch 14 → the low noise amplifier 13 → the terminal 1b.

Thus, the radio frequency circuit 1A can transmit and receive radio frequency signals in Band 20.

### Effects

Even with a small circuit size (three switches and four filters in the second embodiment), the radio frequency circuit 1A can transmit and receive radio frequency signals in Band 28, Band 28B, Band 29, and Band 20.

### Third Embodiment

### Configuration

The configuration of a radio frequency circuit of a third embodiment is the same as the configuration of the radio frequency circuit 1 of the first embodiment (see FIG. 1), and therefore its illustration and descriptions are omitted.

### Operations

The radio frequency circuit 1 of the third embodiment can operate under Power Class (PC) 2 and PC 3.

Under PC 2, the maximum radiated power is 26 dBm. Under PC 3, the maximum radiated power is 23 dBm.

### Operation under PC 2

In an operation under PC 2, the first switch 12 electrically connects the terminal 12a to the terminal 12c. The second switch 14 electrically connects the terminal 14a to the terminal 14c. The third switch 16 electrically connects the terminal 16a to the terminal 16d and electrically connects the terminal 16b to the terminal 16d.

In this state, the radio frequency signal RF1 flows along a path that is the same as the path indicated by the arrow 101 in FIG. 3. Also, the radio frequency signal RF3 flows along a path that is the same as the path indicated by the arrow 102 in FIG. 3.

### Operation under PC 3

In an operation under PC 3, the first switch 12 electrically connects the terminal 12a to the terminal 12d. The second switch 14 electrically connects the terminal 14a to the terminal 14c. The third switch 16 electrically connects the terminal 16b to the terminal 16d and electrically connects the terminal 16c to the terminal 16d.

In this state, the radio frequency signal RF1 flows along a path that is the same as the path indicated by the arrow 111 in FIG. 4. Also, the radio frequency signal RF3 flows along a path that is the same as the path indicated by the arrow 112 in FIG. 4.

### Effects

In the operation under PC 2, the radio frequency signal RF1 leaks into the terminal 1b through a path that is the same as the path indicated by the arrow 131 in FIG. 8.

In the path indicated by the arrow 131, isolation is provided in the section C between the terminals 12a and 12d of the first switch 12, the section D between the terminals 12d and 12b of the first switch 12, and the section E between the terminals 14b and 14a of the second switch 14.

When the attenuation of the radio frequency signal in each of the sections is, for example, 20 dB, the radio frequency signal is attenuated by 60 dB through the entire path indicated by the arrow 131.

Accordingly, the radio frequency circuit 1 can mitigate the reduction in reception sensitivity during an operation under PC 2.

The above-described embodiments are intended to facilitate the understanding of the present disclosure and are not intended to limit the scope of the present disclosure. The present disclosure may be modified or improved without departing from the spirit of the present disclosure, and the present disclosure may include its equivalents.

What is claimed is:

1. A radio frequency circuit comprising:
a radio frequency signal input terminal;
a radio frequency signal output terminal;
a radio frequency signal input-output terminal;
a power amplifier comprising an input terminal that is electrically connected to the radio frequency signal input terminal;
a low noise amplifier comprising an output terminal that is electrically connected to the radio frequency signal output terminal;
a first band pass filter that has a pass band corresponding to an uplink frequency range of Long Term Evolution (LTE) Band 28;
a second band pass filter that has a pass band corresponding to a downlink frequency range of LTE Band 28;
a third band pass filter that has a pass band comprising an uplink frequency range of LTE Band 28B and a downlink frequency range of LTE Band 29; and
a switch group comprising a first terminal that electrically connects an output terminal of the power amplifier to a first end of the first band pass filter, a second terminal that electrically connects a second end of the first band pass filter to the radio frequency signal input-output terminal, a third terminal that electrically connects an input terminal of the low noise amplifier to a first end of the second band pass filter, a fourth terminal that electrically connects a second end of the second band pass filter to the radio frequency signal input-output terminal, a fifth terminal that electrically connects the output terminal of the power amplifier to a first end of the third band pass filter, a sixth terminal that electrically connects a second end of the third band pass filter to the radio frequency signal input-output terminal, and a seventh terminal that electrically connects the input terminal of the low noise amplifier to the first end of the third band pass filter.

2. The radio frequency circuit according to claim 1, further comprising:
a fourth band pass filter that has a pass band corresponding to an uplink frequency range of LTE Band 20,
wherein the second band pass filter has a pass band comprising the downlink frequency range of LTE Band 28 and a downlink frequency range of LTE Band 20; and
wherein the switch group electrically connects the output terminal of the power amplifier to a first end of the fourth band pass filter, electrically connects a second end of the fourth band pass filter to the radio frequency signal input-output terminal, electrically connects the input terminal of the low noise amplifier to the first end of the second band pass filter, and electrically connects the second end of the second band pass filter to the radio frequency signal input-output terminal.

3. The radio frequency circuit according to claim 1,
wherein in an operation under Power Class (PC) 2, the switch group electrically connects the output terminal of the power amplifier to the first end of the first band pass filter, electrically connects the second end of the first band pass filter to the radio frequency signal input-output terminal, electrically connects the input terminal of the low noise amplifier to the first end of the second band pass filter, and electrically connects the second end of the second band pass filter to the radio frequency signal input-output terminal; and
wherein in an operation under Power Class (PC) 3, the switch group electrically connects the output terminal of the power amplifier to the first end of the third band pass filter, electrically connects the second end of the third band pass filter to the radio frequency signal input-output terminal, electrically connects the input terminal of the low noise amplifier to the first end of the second band pass filter, and electrically connects the second end of the second band pass filter to the radio frequency signal input-output terminal.

4. The radio frequency circuit according to claim 1,
wherein the switch group comprises a first switch, a second switch, and a third switch;
wherein the first switch comprises a first terminal that is electrically connected to the output terminal of the power amplifier, a second terminal that is electrically connected to a second terminal of the second switch, a third terminal that is electrically connected to the first end of the first band pass filter, and a fourth terminal that is electrically connected to the first end of the third band pass filter;
wherein the second switch comprises a first terminal that is electrically connected to the input terminal of the low noise amplifier, the second terminal that is electrically connected to the second terminal of the first switch, and a third terminal that is electrically connected to the first end of the second band pass filter; and
wherein the third switch comprises a first terminal that is electrically connected to the second end of the first band pass filter, a second terminal that is electrically connected to the second end of the second band pass filter, a third terminal that is electrically connected to the second end of the third band pass filter, and a fourth terminal that is electrically connected to the radio frequency signal input-output terminal.

5. The radio frequency circuit according to claim 3,
wherein the switch group comprises a first switch, a second switch, and a third switch;
wherein the first switch comprises a first terminal that is electrically connected to the output terminal of the power amplifier, a second terminal that is electrically connected to a second terminal of the second switch, a third terminal that is electrically connected to the first end of the first band pass filter, and a fourth terminal that is electrically connected to the first end of the third band pass filter;
wherein the second switch comprises a first terminal that is electrically connected to the input terminal of the low noise amplifier, the second terminal that is electrically connected to the second terminal of the first switch, and a third terminal that is electrically connected to the first end of the second band pass filter; and
wherein the third switch comprises a first terminal that is electrically connected to the second end of the first band pass filter, a second terminal that is electrically connected to the second end of the second band pass filter, a third terminal that is electrically connected to the second end of the third band pass filter, and a fourth terminal that is electrically connected to the radio frequency signal input-output terminal.

6. The radio frequency circuit according to claim 2,
wherein the switch group comprises a first switch, a second switch, and a third switch;
wherein the first switch comprises a first terminal that is electrically connected to the output terminal of the power amplifier, a second terminal that is electrically connected to a second terminal of the second switch, a third terminal that is electrically connected to the first end of the first band pass filter, a fourth terminal that is electrically connected to the first end of the third band pass filter, and a fifth terminal that is electrically connected to the first end of the fourth band pass filter;
wherein the second switch comprises a first terminal that is electrically connected to the input terminal of the low noise amplifier, the second terminal that is electrically connected to the second terminal of the first switch, and a third terminal that is electrically connected to the first end of the second band pass filter; and
wherein the third switch comprises a first terminal that is electrically connected to the second end of the first band pass filter, a second terminal that is electrically connected to the second end of the second band pass filter, a third terminal that is electrically connected to the second end of the third band pass filter, a fourth terminal that is electrically connected to the radio frequency signal input-output terminal, and a fifth terminal that is electrically connected to the second end of the fourth band pass filter.

7. The radio frequency circuit according to claim 4,
wherein when radio frequency signals in LTE Band 28 are transmitted and received by the radio frequency circuit:
the first switch electrically connects the first terminal to the third terminal,
the second switch electrically connects the first terminal to the third terminal, and
the third switch electrically connects the first terminal to the fourth terminal and electrically connects the second terminal to the fourth terminal;
wherein when radio frequency signals in LTE Band 28B are transmitted and received by the radio frequency circuit:
the first switch electrically connects the first terminal to the fourth terminal,
the second switch electrically connects the first terminal to the third terminal, and
the third switch electrically connects the second terminal to the fourth terminal and electrically connects the third terminal to the fourth terminal; and
wherein when a radio frequency signal in LTE Band 29 are received by the radio frequency circuit:
the first switch electrically connects the second terminal to the fourth terminal,
the second switch electrically connects the first terminal to the second terminal, and
the third switch electrically connects the third terminal to the fourth terminal.

8. The radio frequency circuit according to claim 6,
wherein when radio frequency signals in LTE Band 28 are transmitted and received by the radio frequency circuit:
the first switch electrically connects the first terminal to the third terminal,
the second switch electrically connects the first terminal to the third terminal, and
the third switch electrically connects the first terminal to the fourth terminal and electrically connects the second terminal to the fourth terminal;
wherein when radio frequency signals in LTE Band 28B are transmitted and received by the radio frequency circuit:
the first switch electrically connects the first terminal to the fourth terminal,
the second switch electrically connects the first terminal to the third terminal, and
the third switch electrically connects the second terminal to the fourth terminal and electrically connects the third terminal to the fourth terminal; and
wherein when a radio frequency signal in LTE Band 29 are received by the radio frequency circuit:
the first switch electrically connects the second terminal to the fourth terminal,
the second switch electrically connects the first terminal to the second terminal, and
the third switch electrically connects the third terminal to the fourth terminal.

9. The radio frequency circuit according to claim 6, wherein when radio frequency signals in LTE Band 20 are transmitted and received by the radio frequency circuit:
the first switch electrically connects the first terminal to the fifth terminal,
the second switch electrically connects the first terminal to the third terminal, and
the third switch electrically connects the second terminal to the fourth terminal and electrically connects the fourth terminal to the fifth terminal.

10. The radio frequency circuit according to claim 4,
wherein in an operation under Power Class (PC) 2:
the first switch electrically connects the first terminal to the third terminal,
the second switch electrically connects the first terminal to the third terminal, and
the third switch electrically connects the first terminal to the fourth terminal and electrically connects the second terminal to the fourth terminal; and
wherein in an operation under Power Class (PC) 3,
the first switch electrically connects the first terminal to the fourth terminal,
the second switch electrically connects the first terminal to the third terminal, and
the third switch electrically connects the second terminal to the fourth terminal and electrically connects the third terminal to the fourth terminal.
